(19) United States
(12) Patent Application Publication
(10) Pub. No.: US 2024/0208764 A1
(43) Pub. Date: Jun. 27, 2024

(54) PRINTER

(71) Applicant: FUJITSU COMPONENT LIMITED, Tokyo (JP)

(72) Inventors: Takeshi Kubota, Tokyo (JP); Yuji Yada, Tokyo (JP); Tatsuya Oguchi, Tokyo (JP); Tetsuhiro Ishikawa, Tokyo (JP); Youichi Takamura, Tokyo (JP)

(21) Appl. No.: 18/527,848

(22) Filed: Dec. 4, 2023

(30) Foreign Application Priority Data
Dec. 21, 2022 (JP) 2022-204598

(51) Int. Cl. B65H 37/02; B41J 3/407; B41J 11/04; B41J 11/70; B41J 13/03; B41J 29/13; B65H 35/00

(52) U.S. Cl. CPC B65H 37/02; B41J 3/4075; B41J 11/04; B41J 11/70; B41J 13/03; B41J 29/13; B65H 35/0006; B65H 2701/192

(57) ABSTRACT

A printer according to one embodiment of the present disclosure includes a printing portion configured to perform printing on a recording sheet, a cutter including a fixed blade and a movable blade and configured to cut the recording sheet along a width direction thereof by movement of the movable blade, an adhesive transfer unit configured to add an adhesive to a rear surface of the recording sheet, and a transfer roller disposed to face the adhesive transfer unit and configured to press the recording sheet toward the adhesive transfer unit and transport the recording sheet. The adhesive transfer unit is integrally assembled together with the movable blade, and provided to move together with the movable blade along a moving direction of the movable blade.

### CROSS-REFERENCE TO RELATED APPLICATION

This application is based upon and claims the benefit of priority of the prior Japanese Patent Application No. 2022-204598 filed on Dec. 21, 2022, the entire contents of which are incorporated herein by reference.

### BACKGROUND

A certain aspect of the embodiments is related to a printer.

There are printers that are known to print on a front surface of an elongated recording medium such as a roll sheet, apply an adhesive to a rear surface thereof, and cut the printed recording medium, thereby producing a printed product such as a label sheet.

### RELATED ART

[Patent Document 1] Unexamined Japanese Patent Application Publication No. 2014-234293

The printer described in Patent Document 1 discloses a configuration in which printing is performed without transferring an adhesive to a recording medium by spacing an adhesive transfer device from the recording medium. In this configuration, a driving source for spacing the adhesive transfer device from the recording medium increases the size of the resulting device.

### SUMMARY

In one embodiment, provided is a printer that can form a printed product by adding an adhesive to a recording medium and cutting the recording medium, with the size of the device being suppressed from increasing.

A printer according to one embodiment of the present disclosure includes: a printing portion configured to perform printing on a recording medium; a cutting portion including a fixed blade and a movable blade and configured to cut the recording medium along a width direction thereof by movement of the movable blade; an adhesive adding portion configured to add an adhesive to one surface of the recording medium; and a transfer roller disposed to face the adhesive adding portion and configured to press the recording medium toward the adhesive adding portion and transport the recording medium. The adhesive adding portion is integrally assembled together with the movable blade, and provided to move together with the movable blade along a moving direction of the movable blade.

According to the present disclosure, it is possible to provide a printer that can form a printed product by adding an adhesive to a recording medium and cutting the recording medium, with the size of the device being suppressed from increasing.

### BRIEF DESCRIPTION OF DRAWINGS

FIG. 1 is a side view illustrating a schematic configuration of a printer according to an embodiment;

FIG. 2 is a plan view illustrating a configuration near a printing portion and a transfer roller of the printer;

FIG. 3 is a plan view of a transport guide;

FIG. 4 is a view illustrating arrangement of the transfer roller, the transport guide, and an adhesive transfer unit;

FIG. 5 is a side view illustrating a state in which a cover of the printer is opened;

FIG. 6 is a block diagram illustrating an input-output relationship of a control portion;

FIG. 7 is a flowchart of printing control of the printer according to the embodiment;

FIG. 8 is a view illustrating a first phase of a plain sheet printing mode (first position);

FIG. 9 is a view illustrating a second phase of the plain sheet printing mode (third position);

FIG. 10 is a view illustrating a third phase of the plain sheet printing mode (first position);

FIG. 11 is a view illustrating a first phase of a label sheet printing mode (second position);

FIG. 12 is a view illustrating a positional relationship between the transfer roller and the adhesive transfer unit at the second position;

FIG. 13 is a view illustrating a second phase of the label sheet printing mode (third position);

FIG. 14 is a view illustrating a third phase of the label sheet printing mode (second position);

FIG. 15A is a view illustrating a state in which the transfer roller is at the second position;

FIG. 15B is an explanatory view of the movement of the transfer roller at the time of moving from the second position to the third position; and

FIG. 15C is a view illustrating a state in which the transfer roller is at the third position.

### DESCRIPTION OF EMBODIMENTS

Hereinafter, a description will be given of the embodiment of the present invention with reference to the drawings.

The embodiments will now be described with reference to the accompanying drawings. For ease of understanding, the same components throughout the drawings will be assigned the same reference numerals and symbols to the extent possible, and overlapping description will be omitted.

Note that, in the following description, an X direction, a Y direction, and a Z direction are perpendicular to each other. The X direction and the Y direction are the horizontal directions, and the Z direction is the vertical direction. A positive X-direction side is a downstream side of a transport direction S2, and a negative X-direction side is an upstream side of the transport direction S2. The Y direction is a width direction of a recording sheet P, and is an extending direction of a rotation shaft of, for example, a transfer roller 17. The Z direction is a moving direction of an upward-and-downward moving block 13. Also, in the following, for the sake of convenience, the positive Z-direction side may be referred to as an upper side, and the negative Z-direction side may be referred to as a lower side.

### <Configuration of the Printer>

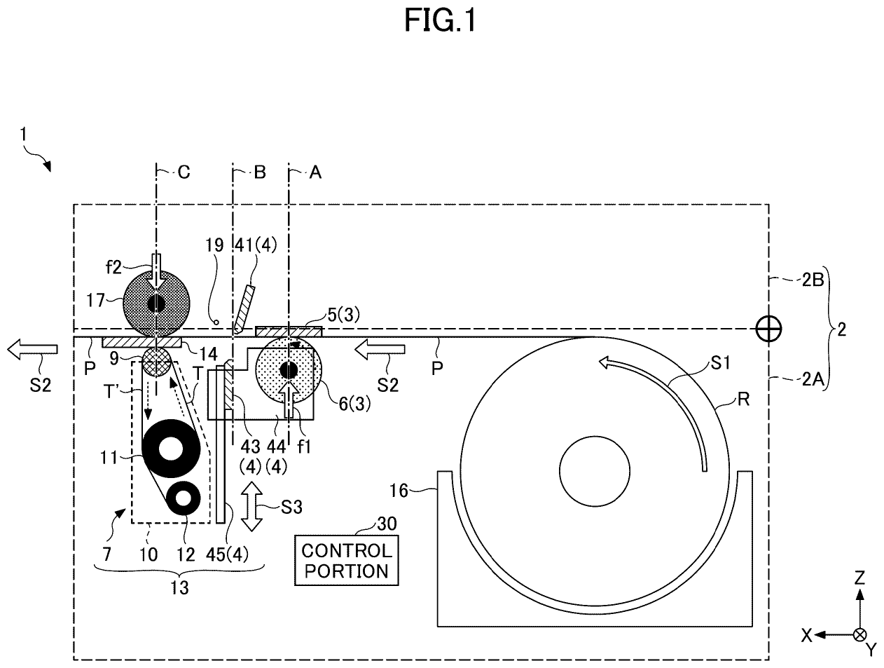

Referring to FIG. 1 to FIG. 6, the configuration of a printer 1 according to the present embodiment will be described.

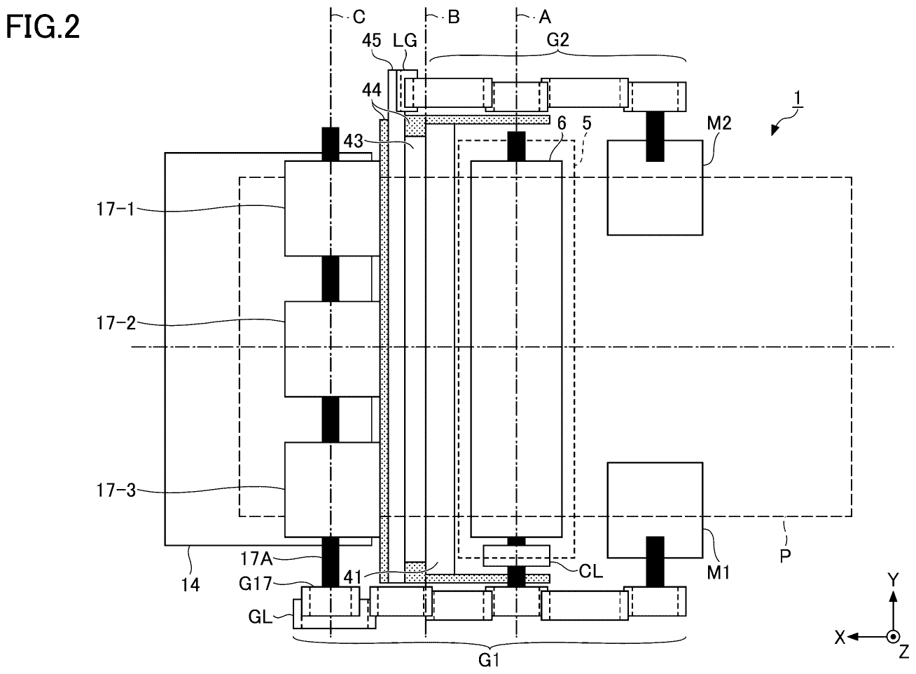

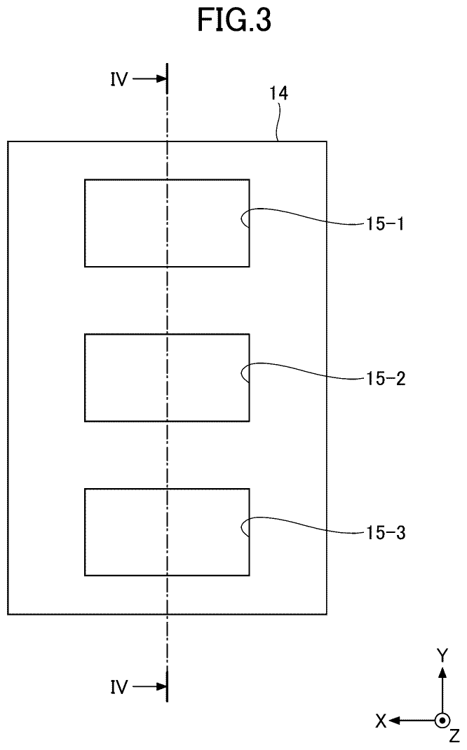

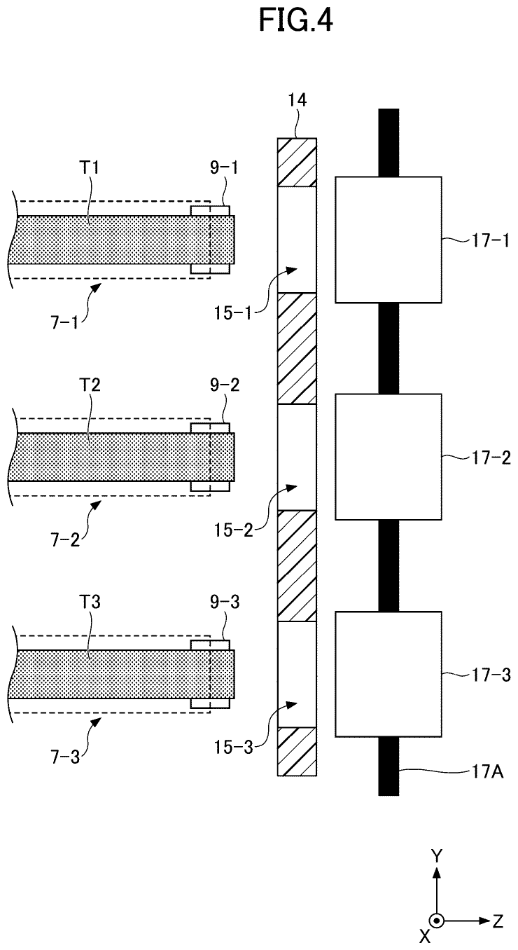

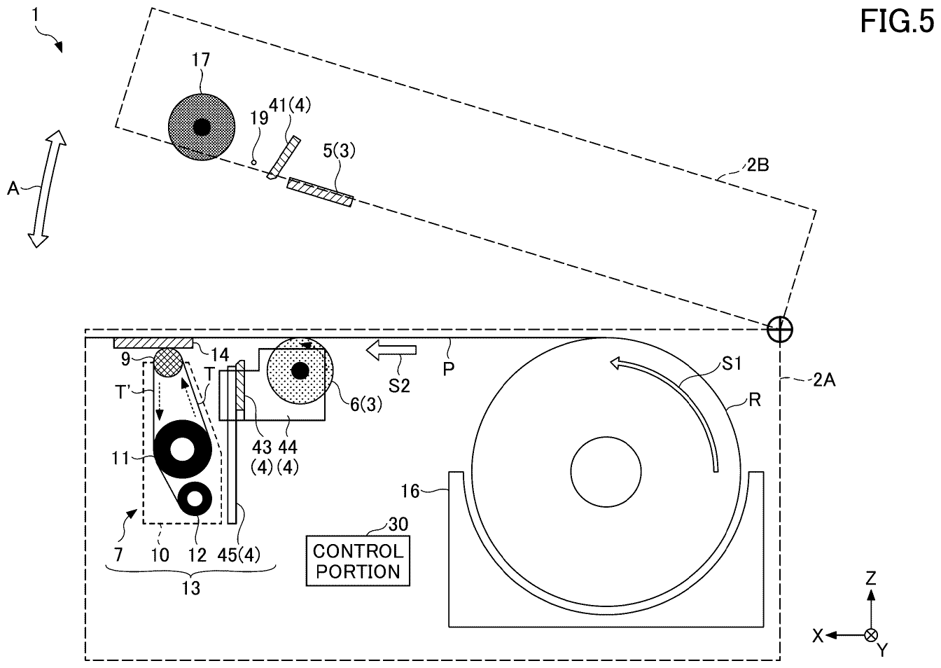

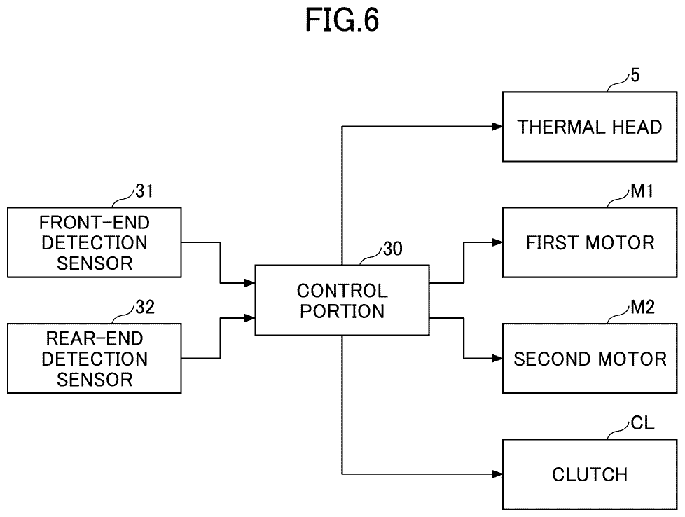

FIG. 1 is a side view illustrating the schematic configuration of the printer 1 according to the embodiment. FIG. 2 is a plan view illustrating the configuration near a printing portion 3 and a transfer roller 17 of the printer 1. FIG. 3 is a plan view of a transport guide 14. FIG. 4 is a view illustrating arrangement of the transfer roller 17, the transport guide 14, and an adhesive transfer unit 7. FIG. 5 is a side view illustrating a state in which a cover 2B of the printer 1 is opened. FIG. 6 is a block diagram illustrating an input-output relationship of a control portion 30.

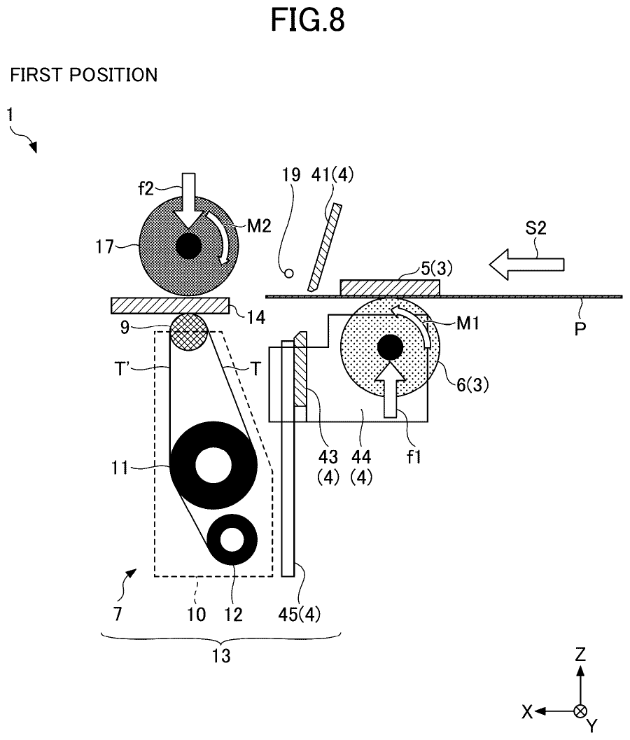

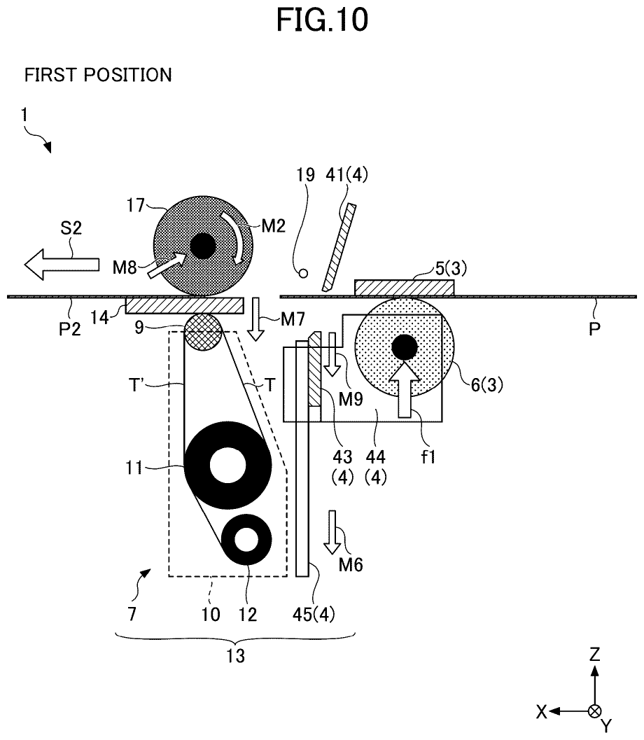

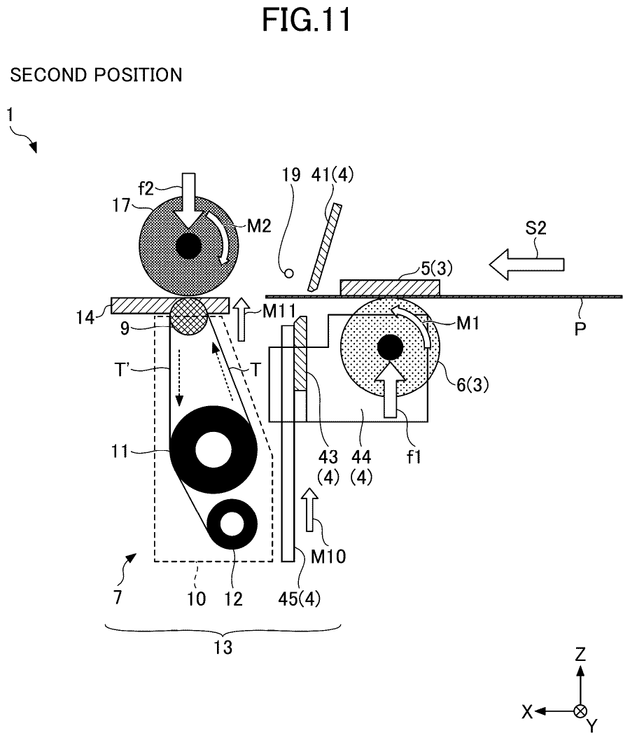

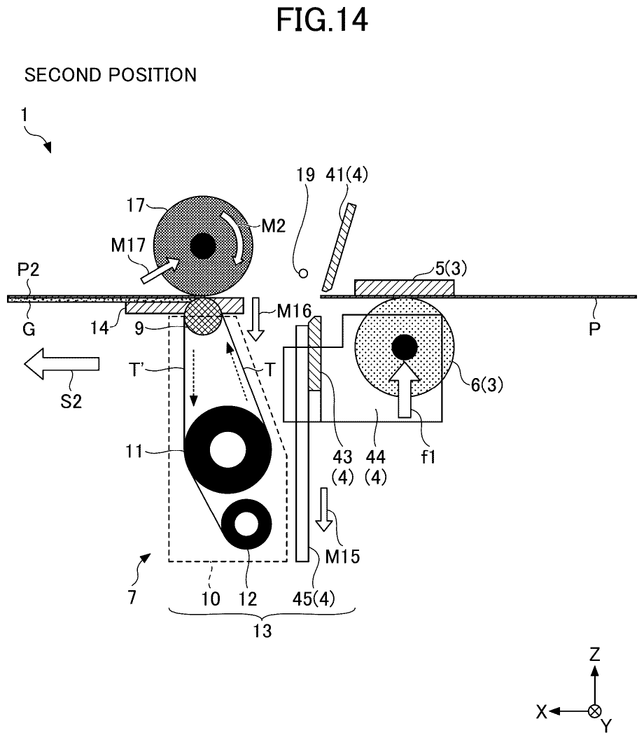

The printer 1 according to the present embodiment can perform two types of printing; i.e., “label sheet printing” and “plain sheet printing”, on the elongated recording sheet P serving as a recording medium. The “label sheet printing” performs printing on a front surface of the recording sheet P and applies an adhesive G to a rear surface of the recording sheet P, thereby producing a label sheet having an adhesive surface on the rear surface thereof (see FIG. 11 to FIG. 14). The “plain sheet printing” performs printing on the front surface of the recording sheet P but does not apply the adhesive G to the rear surface of the recording sheet P, thereby producing a plain sheet having no adhesive surface on the rear surface thereof, such as a receipt (see FIG. 8 to FIG. 10). Also, the printer 1 of the present embodiment can perform the above-described label sheet printing or plain sheet printing on the elongated recording sheet P and cut the recording sheet P after the printing, thereby outputting a printed product P2 in the form of a sheet (see FIG. 10 and FIG. 14).

As illustrated in FIG. 1, the printer 1 includes the printing portion 3, a cutter 4 (cutting portion), the adhesive transfer unit 7 (adhesive adding portion), and the transfer roller 17.

The printer 1 stores a roll sheet R in a roll storing portion 16 in the device body. The roll sheet R is a roll of the recording sheet P that is a thermosensitive sheet.

As illustrated in, for example, FIG. 1, the roll sheet R is stored in the roll storing portion 16 with the roll sheet R being centrifugally wound from the center counterclockwise as viewed from a negative Y-direction side. Also, the roll sheet R is disposed in the roll storing portion 16 so as to be able to rotate about a Y axis. Therefore, when the recording sheet P is pulled from an upper end portion of the roll sheet R toward the positive X-direction, the roll sheet R is rotated in the roll storing portion 16 in the same direction S1 as the direction in which the roll sheet R is wound, and the recording sheet P is pulled out from the roll storing portion 16.

The printing portion 3, the cutter 4, and the adhesive transfer unit 7 are disposed in order along the upstream side to the downstream side of the transport direction S2. Also, the transfer roller 17 is disposed to face the adhesive transfer unit 7 via a transport path over which the recording sheet P is transported.

The printing portion 3 includes a thermal head 5 (recording head) configured to perform printing on the recording sheet P and a platen roller 6 disposed to face the thermal head 5 and configured to transport the recording sheet P downstream. In the example of FIG. 1, the thermal head 5 is disposed on the positive Z-direction side of the transport path of the recording sheet P, and can perform printing on a surface on the positive Z-direction side (front surface) of the recording sheet P.

The platen roller 6 is disposed on the negative Z-direction side of the transport path of the recording sheet P, and is biased toward the positive Z-direction by a biasing force f1. The biasing force f1 can be generated by, for example, an elastic member (e.g., a spring) connected to a rotation shaft of the platen roller 6. The platen roller 6 transports the recording sheet P downstream of the transport direction by rotating while pressing, by the biasing force f1, a surface on the negative Z-direction side (rear surface) of the recording sheet P passing between the platen roller 6 and the thermal head 5. Note that, in the present embodiment, the thermal head 5 is used as a printing component because the recording sheet P is a thermosensitive sheet; however, a printing component other than the thermal head 5 may be used in accordance with the type of a recording medium.

The cutter 4 includes a fixed blade 41 and a movable blade 43, and the fixed blade 41 and the movable blade 43 extend in the width direction of the recording sheet P. As illustrated in FIG. 1, the fixed blade 41 is disposed on the positive Z-direction side of the recording sheet P, and the movable blade 43 is disposed on the negative Z-direction side thereof. The movable blade 43 is movable, by a driving force transmitted from a second motor M2 as illustrated in, for example, FIG. 2, along a direction S3 that is orthogonal to the transport direction S2 and the width direction of the recording sheet P. The cutter 4 can cut the recording sheet P along the width direction thereof by the movable blade 43 moving toward the positive Z-direction across the recording sheet P.

The adhesive transfer unit 7 adds the adhesive G to one surface of the recording sheet P. In the example of FIG. 1, the adhesive transfer unit 7 is disposed on the negative Z-direction side of the recording sheet P, and can apply the adhesive in contact with the surface on the negative Z-direction side (rear surface) of the recording sheet P. Note that, as described below, the adhesive transfer unit 7 is movable together with the movable blade 43 along the moving direction S3 of the movable blade 43.

The transfer roller 17 is disposed on the positive Z-direction side of the recording sheet P, and is biased toward the negative Z-direction side by a biasing force f2. The biasing force f2 can be generated by, for example, an elastic member (e.g., a spring) connected to a rotation shaft of the transfer roller 17. At a position that faces the transfer roller 17 and is on the negative Z-direction side of the recording sheet P, the transport guide 14 is disposed along the transport path of the recording sheet P. The upper surface of the transport guide 14 on the positive Z-direction side is provided with a plane along the transport direction S2. The transfer roller 17 transports the recording sheet P downstream of the transport direction S2 by rotating while pressing, by the biasing force f2, the front surface of the recording sheet P passing between the transfer roller 17 and the transport guide 14.

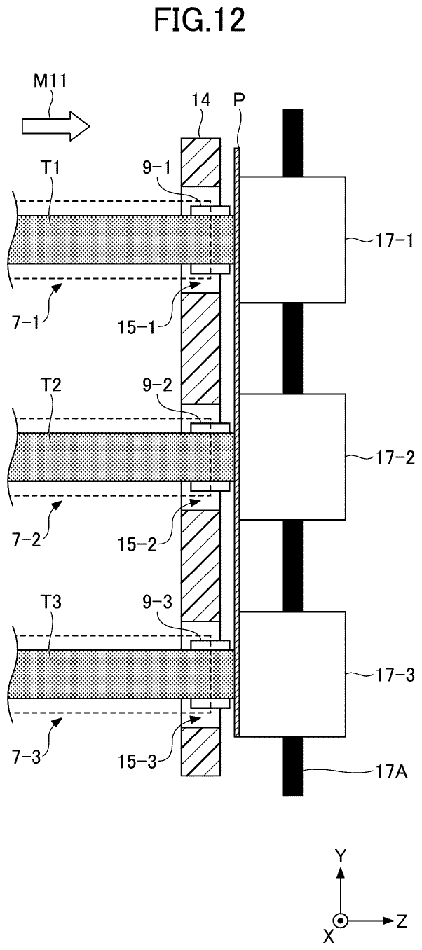

Also, as described below, the adhesive transfer unit 7 passes through an insert hole 15 of the transport guide 14 (see, for example, FIG. 3, FIG. 4, and FIG. 12) and is exposed to the positive Z-direction side of the upper surface of the transport guide 14. Then, the adhesive transfer unit 7 moves upward to such a position as to contact the transfer roller 17, and contacts the rear surface of the recording sheet P passing between the adhesive transfer unit 7 and the transfer roller 17 and can add the adhesive G thereto.

As illustrated in FIG. 2, a first motor M1, a second motor M2, and two gear lines G1 and G2 are provided in the printer 1. The first motor M1 is connected to the gear line G1, and the second motor M2 is connected to the gear line G2. The gear line G1 includes a plurality of gears that are engaged with each other. The rotation axis of each of the gears is along the Y direction, and the gears are arranged along the X direction.

The first motor M1 is connected to the gear, of the gear line G1, at the most upstream side of the transport direction. A gear GL, of the gear line G1, at the most downstream side of the transport direction is engaged with a gear G17 that is coaxially disposed with a rotation shaft 17A of the transfer roller 17. The gear G17 is connected to the rotation shaft 17A and rotates together with the rotation shaft 17A. Also, one gear in the middle of the gear line G1 is connected to the rotation shaft of the platen roller 6. With this configuration of the gear line G1, a driving force output from the first motor M1 is transmitted to the platen roller 6 and the transfer roller 17 via the gear line G1, and can rotate the platen roller 6 and the transfer roller 17.

Also, a clutch CL is disposed between the rotation shaft of the platen roller 6 and the gear line G1. By operating the clutch CL, it is possible to release the connection between the rotation shaft of the platen roller 6 and the gear line G1. With the connection therebetween being released by the clutch CL, the driving force output from the first motor M1 is not transmitted to the platen roller 6 and is only transmitted to the transfer roller 17. This can rotate only the transfer roller 17 without rotating the platen roller 6. Note that, the clutch CL may be a clutch of a given type, such as an electromagnetic clutch or a spring clutch using a solenoid.

The second motor M2 is connected to the gear, of a gear line G2, at the most upstream side of the transport direction. The gear, of the gear line G2, at the most downstream side of the transport direction is engaged with a rack gear LG provided in a movable blade rack 45 of the cutter 4. The rack gear LG is disposed such that the teeth thereof are arranged along the Z direction. The movable blade 43 and the adhesive transfer unit 7 are connected to the movable blade rack 45. Thereby, the driving force output from the second motor M2 is transmitted to the movable blade rack 45 via the gear line G2 and the rack gear LG, and can move, upward and downward, the movable blade 43 and the adhesive transfer unit 7 connected to the movable blade rack 45.

Note that, position A of the printer 1 as illustrated in FIG. 1 and FIG. 2 indicates “printing position A” at which printing is performed by the printing portion 3, position B thereof indicates “cutting position B” at which the recording sheet P is cut by the cutter 4, and position C thereof indicates “adhesive transfer position C” at which the adhesive G is added to the recording sheet P by the adhesive transfer unit 7.

At the printing position A, the printing portion 3, which is configured to perform printing on the recording sheet P, is provided. The printing portion 3 includes: the thermal head 5 configured to generate heat in accordance with printing information for printing the thermosensitive surface of the recording sheet P from the roll sheet R; and the platen roller 6 configured to transport the recording sheet P while pressing the recording sheet P against the thermal head 5 by an unillustrated pressing unit.

At the cutting position B, the cutter 4, which is configured to cut the recording sheet P, is provided. The cutter 4 includes the fixed blade 41, the movable blade 43, a cutter frame 44, and the movable blade rack 45, and cuts the recording sheet P. At this time, a sheet press member 19 presses the recording sheet P so as to be against the movement of the movable blade 43, thereby enhancing cutting performance for, especially, thin sheets. In order to realize this function, preferably, the sheet press member 19 is disposed on the positive Z-direction side of the recording sheet P and on the downstream side of the transport direction with respect to the movable blade 43, and is disposed at a position that is approximately the same in the Z direction as the upper end of the movable blade 43 that has moved up to the position at which the movable blade 43 cuts the recording sheet P.

In order to move the movable blade 43 in the moving direction S3, as illustrated in FIG. 2, the movable blade 43 is retained by the movable blade rack 45 provided with the rack gear LG that transmits, via the gear line G2, the driving force from the second motor M2 in the printer 1. Furthermore, as illustrated in FIG. 1 and FIG. 2, the cutter frame 44 retains the platen roller 6 and the movable blade rack 45, and has a role in determining a relative positional relationship between the thermal head 5 and the fixed blade 41. By pressing, with the cutter frame 44, the upstream side and the downstream side of the movable blade rack 45 in the transport direction S2, it is possible to prevent tilting during moving of the movable blade 43.

At the adhesive transfer position C, the adhesive transfer unit 7 is provided. The adhesive transfer unit 7 includes a transfer part 9 configured to supply an adhesive tape sheet T to the position C and transfer the adhesive G of the adhesive tape sheet T to the rear surface of the recording sheet P.

The movable blade rack 45 preferably detachably retains the adhesive transfer unit 7 that houses, for example, the adhesive tape sheet T and the transfer part 9. Note that, such a connection structure for connecting the adhesive transfer unit 7 to the movable blade rack 45 can be a given structure such as a locking structure between a projection and a hole, or a screw fastening. Thereby, in accordance with the upward-and-downward movement of the movable blade rack 45, the movable blade 43 and the transfer part 9 can be moved in association with each other in terms of the moving direction and the moving amount. Also, since the adhesive transfer unit 7 can be removed from the movable blade rack 45, replacement or maintenance of the adhesive transfer unit 7 can become easier, and the lifetime of the device can be improved.

The adhesive transfer unit 7 includes a casing 10, an accommodation roller 11, the transfer part 9, and a recovery roller 12. The casing 10 houses therein the accommodation roller 11, the transfer part 9, the recovery roller 12, and the adhesive tape sheet T. The accommodation roller 11 winds and accommodates the adhesive tape sheet T before transfer in the casing 10. The transfer part 9 is a member in the form of a roller that is rotatable about the Y axis, and is disposed so that a part thereof is exposed from the upper end portion of the casing 10. Also, the transfer part 9 winds the adhesive tape sheet T, which is fed from the accommodation roller 11, along the outer circumferential surface of the roller so that the adhesive side of the adhesive tape sheet T becomes exposed externally. This makes it possible for the adhesive of the adhesive tape sheet T to contact the rear surface of the recording sheet P that is an object to which the adhesive is to be transferred. The transfer part 9 contacts the recording sheet P moving along the transport direction S2 while being pressed toward the adhesive transfer unit 7 by the transfer roller 17, and rotates so as to move the adhesive tape sheet T toward the transport direction S2. Thereby, the adhesive of the adhesive tape sheet T is transferred to the rear surface of the recording sheet P.

The recovery roller 12 winds and recovers a tape sheet T′ after the adhesive has been transferred. Since the accommodation roller 11 and the recovery roller 12 are connected to each other and driven via, for example, a gear or a belt, it is possible to match the amount of the adhesive tape sheet T pulled from the accommodation roller 11 with the amount of the tape sheet T′ wound around the recovery roller 12. Thereby, the adhesive tape sheet T can move without loosening in the adhesive transfer unit 7. Note that, the structure of the adhesive transfer unit 7 for transferring the adhesive is similar to that of a well-known tape glue or a correction tape sheet. For example, the adhesive transfer unit 7 is connected to the movable blade rack 45 via the casing 10.

A motive force is transmitted from the second motor M2 via the gear line G2 to the rack gear LG in the movable blade rack 45, and such a rotational driving force is converted by the rack gear LG to a driving force directed in a straight-line direction toward the Z direction. Thereby, the movable blade rack 45 moves upward and downward, and along with this movement, the movable blade 43 and the adhesive transfer unit 7 move together with and in the same direction as the movable blade rack 45.

The movable blade 43 and the adhesive transfer unit 7 are regarded as the “upward-and-downward moving block 13” that moves in the upward-and-downward S3 together with the movable blade rack 45 by the driving force of the sole second motor M2.

Also, as illustrated in FIG. 4, adhesive transfer units 7-1, 7-2, and 7-3 can be provided along the Y direction; i.e., the width direction of the recording sheet P. The adhesive transfer units respectively include adhesive tape sheets T1, T2, and T3. As illustrated in FIG. 3 and FIG. 4, insert holes 15-1, 15-2, and 15-3 are formed in the transport guide 14 at positions facing the adhesive transfer units 7-1, 7-2, and 7-3. With this configuration, by passing transfer parts 9-1, 9-2, and 9-3 of the adhesive transfer units 7-1, 7-2, and 7-3 through the insert holes 15-1, 15-2, and 15-3 and moving the transfer parts 9-1, 9-2, and 9-3 to contact positions with the transfer roller 17, the adhesive G can be applied by the adhesive tape sheets T1, T2, and T3 to given positions in the width direction of the rear surface of the recording sheet P. The positions to which the adhesive is to be applied may be selectively set by, for example, a user of the printer 1. Note that, the number of the adhesive transfer units 7-1, 7-2, and 7-3, the adhesive tape sheets T1, T2, and T3, or the insert holes 15-1, 15-2, and 15-3 is three in the example of FIG. 4, but may be two or may be more than three.

In the present embodiment, the transfer part 9 is a roller member that is rotatable about the Y direction serving as the rotation axis, and as illustrated in FIG. 4, the adhesive tape sheet T is disposed along the roll-shaped outer circumferential surface of the transfer part 9 such that the adhesive surface of the adhesive tape sheet T is exposed externally. When the adhesive transfer unit 7 moves upward to a position at which the transfer part 9 provided with the adhesive tape sheet T contacts the transfer roller 17 (see FIG. 12), the transfer roller 17 rotates while pressing the transfer part 9, and thus the transfer part 9 also rotates. As a result, the adhesive tape sheet T wound around the transfer part 9 also moves along the transport direction S2 at the contact portion with the recording sheet P. Thereby, it is possible to transfer the adhesive G of the adhesive tape sheet T to the rear surface of the recording sheet P held by the transfer part 9 and the transfer roller 17.

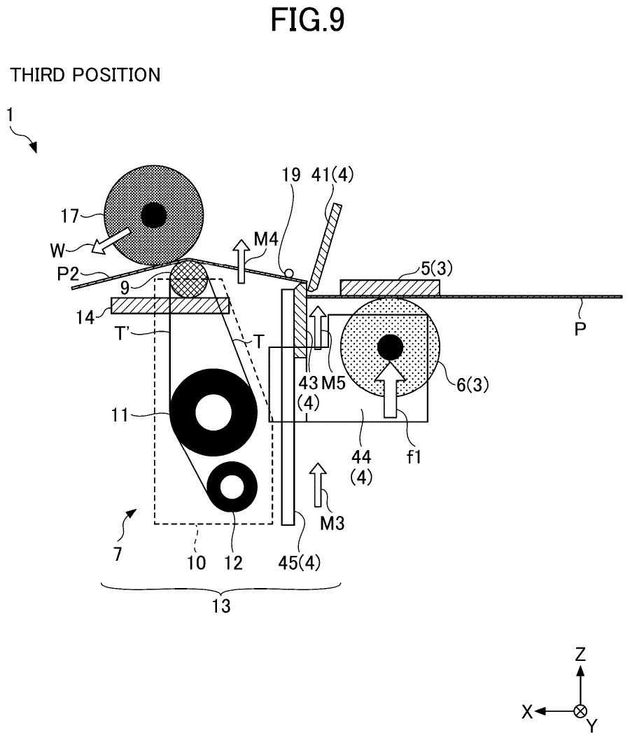

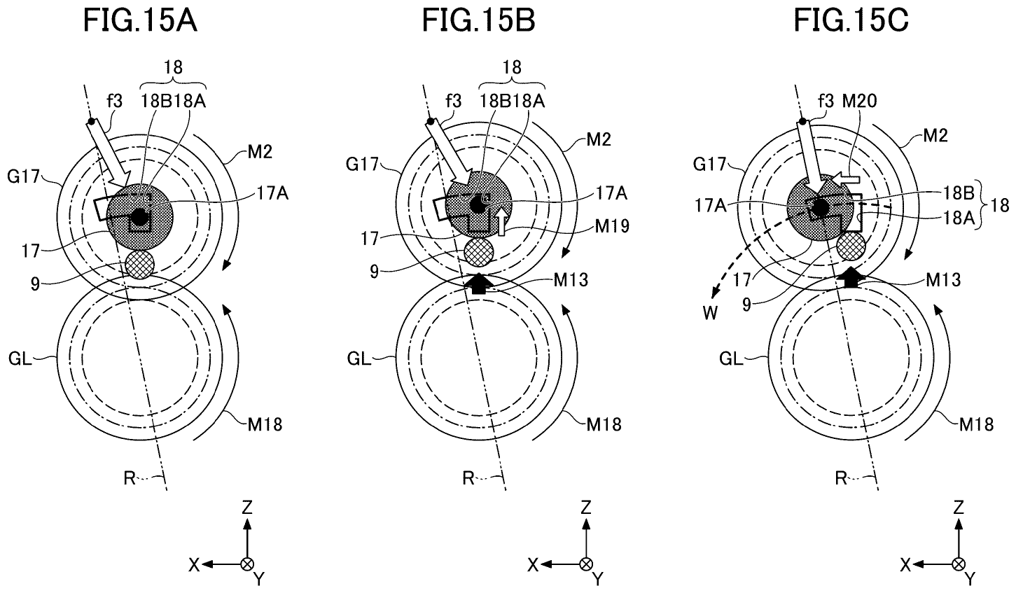

When the upper surface of the transfer part 9 is disposed on the negative Z-direction side of the upper surface of the transport guide 14, the rotation shaft 17A of the transfer roller 17 and the rotation shaft of the transfer part 9 are disposed at approximately the same position in the transport direction. Meanwhile, the transfer roller 17 has a moving structure in which when the upper surface of the transfer part 9 moves toward the positive Z-direction side of the upper surface of the transport guide 14 (see FIG. 9), the rotation shaft 17A moves downstream of the rotation shaft of the transfer part 9 in the transport direction S2. This moving structure will be described below with reference to FIG. 15A to FIG. 15C.

As illustrated in, for example, FIG. 2 and FIG. 4, in the present embodiment, the transfer roller 17 includes three transfer rollers 17-1, 17-2, and 17-3 that are the same number of the adhesive transfer units 7-1, 7-2, and 7-3, and the transfer rollers 17-1, 17-2, and 17-3 are disposed in the Y direction at positions facing the adhesive transfer units 7-1, 7-2, and 7-3 and rotatably disposed on the common rotation shaft 17A. However, the transfer roller 17 is not limited to this configuration even if there are a plurality of adhesive transfer units; e.g., the adhesive transfer units 7-1, 7-2, and 7-3, as long as the transfer roller 17 can apply a similar pressing force and a similar rotating force to each of the adhesive transfer units. For example, the transfer roller 17 may be a single roller that is at least longer than the length between both ends in the Y direction of each adhesive transfer unit. In the following, for the sake of convenience, the components as illustrated in FIG. 3 and FIG. 4 will collectively be referred to as “adhesive transfer unit 7”, “transfer part 9”, “insert hole 15”, “transfer roller 17”, and “adhesive tape sheet T”.

The printer 1 includes the control portion 30 configured to control the operation of each of the components related to the above-described printing. As illustrated in FIG. 6, the printer 1 includes, for example, a front-end detection sensor 31 and a rear-end detection sensor 32 as components configured to detect the position of the recording sheet P on the transport path. The front-end detection sensor 31 and the rear-end detection sensor 32 are electrically connected to the control portion 30.

The front-end detection sensor 31 detects that the front-end portion of the recording sheet P has reached the printing position A, and outputs the detection result to the control portion 30. The rear-end detection sensor 32 detects that the rear end of the printed product P2 after cutting with the cutter 4 has reached the adhesive transfer position C, and outputs the detection result to the control portion 30. As the front-end detection sensor 31 and the rear-end detection sensor 32, for example, well-known sensors such as photoelectric sensors can be used. The front-end detection sensor 31 and the rear-end detection sensor 32 are respectively disposed at the printing position A or in the vicinity thereof and the adhesive transfer position C or in the vicinity thereof so that the front-end detection sensor 31 and the rear-end detection sensor 32 can detect the presence or absence of the recording sheet P at the printing position A and the adhesive transfer position C. Note that, the front-end detection sensor 31 and the rear-end detection sensor 32 are examples of the components configured to detect the position of the recording sheet P on the transport path, and may be other components.

Also, the control portion 30 is electrically connected to the thermal head 5, the first motor M1, the second motor M2, and the clutch CL, and outputs a control command to the components to thereby control the operations of the components. For example, the control portion 30 can control a series of printing operations by outputting, to the thermal head 5, the first motor M1, the second motor M2, or the clutch CL, an operation command on printing in accordance with the position of the recording sheet P on the transport path based on the detection results obtained by the front-end detection sensor 31 and the rear-end detection sensor 32.

In particular, in the present embodiment, the control portion 30 can move the upward-and-downward moving block 13 between three-phase positions in the Z direction based on the detection results obtained by the front-end detection sensor 31 and the rear-end detection sensor 32. In the following, these three-phase positions will be referred to as “first position”, “second position”, and “third position”.

The first position is a state in which both of the adhesive transfer unit 7 and the movable blade 43 are at positions spaced from the transport path of the recording sheet P in the negative Z direction (see FIG. 8 and FIG. 10).

The second position is a state in which the adhesive transfer unit 7 is at such a position as to be able to add the adhesive to the recording sheet P and the movable blade 43 is at such a position as to be unable to cut the recording sheet P on the transport path of the recording sheet P (see FIG. 11 and FIG. 14).

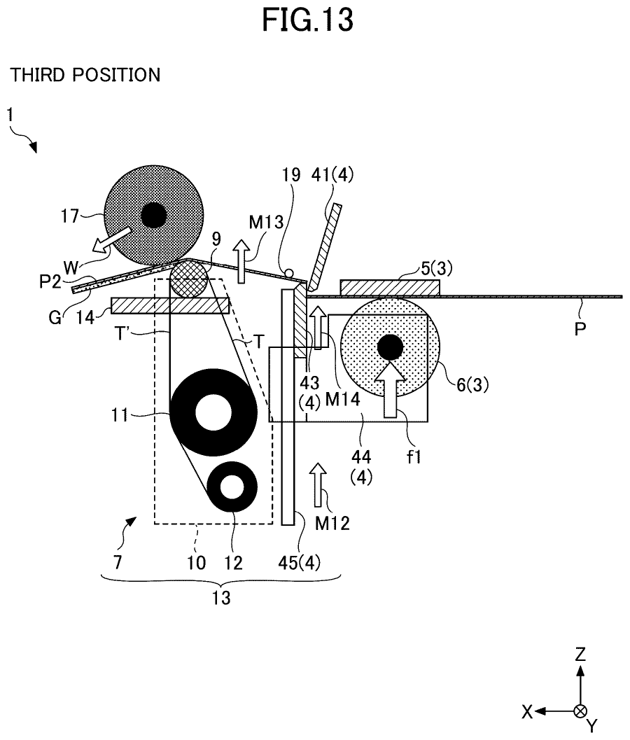

The third position is a state in which both of the adhesive transfer unit 7 and the movable blade 43 have moved toward the positive Z-direction across the transport path and are at positions exceeding the transport path of the recording sheet P, and the movable blade 43 is at such a position as to be able to cut the recording sheet P on the transport path (see FIG. 9 and FIG. 13).

The third position is higher in the Z direction than the second position, and the second position is higher in the Z direction than the first position. Also, at the third position, the transfer roller 17 moves along the transport path so that the adhesive transfer unit 7 can move to a position exceeding the transport path.

Physically speaking, the control portion 30 includes a central processing unit (CPU), a random access memory (RAM) and a read only memory (ROM), which are storage devices, and a communication module such as a network card. The functions of the control portion 30 are realized by reading-in of predetermined computer software on hardware such as a ROM, thereby operating the communication module under control of the CPU and reading-out and writing-in data in the RAM.

As illustrated in FIG. 1 and FIG. 5, a housing 2 of the printer 1 includes a body 2A and the cover 2B. As indicated by arrow A in FIG. 5, the cover 2B is provided to the body 2A so as to be pivotally rotatable about a predetermined rotation axis. Thereby, by pivotally rotating the cover 2B so as to be apart from the body 2A, the housing 2 can be opened. In this opened state, by pivotally rotating the cover 2B so as to be closer to the body 2A, the housing 2 can be closed.

In the present embodiment, of the above-described components, the movable blade 43, the movable blade rack 45, and the adhesive transfer unit 7 (corresponding to the upward-and-downward moving block 13), the platen roller 6, and the transport guide 14 are provided in the body 2A. Meanwhile, the thermal head 5, the fixed blade 41, and the transfer roller 17 are provided in the cover 2B.

When the cover 2B is opened, the transport path of the printer 1 can be exposed. Thus, it can become easier to address jamming of the recording sheet P. Also, since the components disposed in the cover 2B and the body 2A can be readily replaced, maintainability of the components can also be improved.

### <Printing Control>

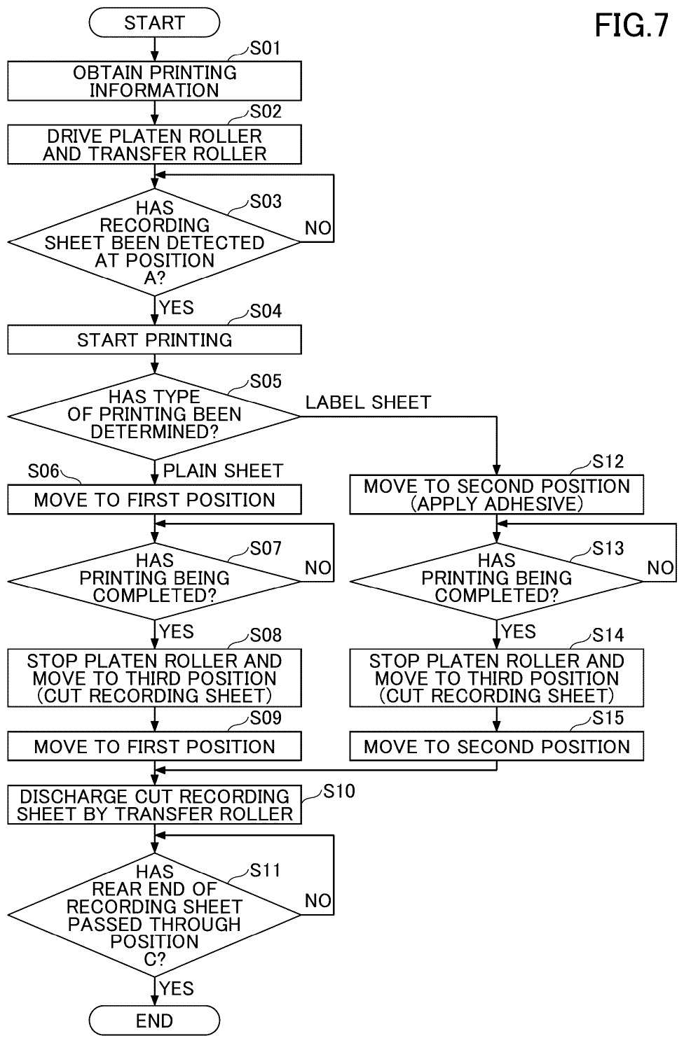

Referring to FIG. 7 to FIGS. 15A to 15C, the printing control by the printer 1 according to the present embodiment will be described. FIG. 7 is a flowchart of the printing control of the printer 1 according to the embodiment. The steps of the flowchart as illustrated in FIG. 7 are performed by the control portion 30 when a user operates the label sheet printing or the plain sheet printing using the printer 1.

In S01, printing information is obtained. The printing information includes information on, for example, types and arrangement of letters, figures, or the like to be printed on the recording sheet P, and a type of printing (the plain sheet printing or the label sheet printing). The printing information is obtained by the control portion 30 in response to, for example, input by the user to a personal computer (PC) or the like connected to the printer 1.

In S02, the platen roller 6 and the transfer roller 17 are driven. The control portion 30 outputs, to the first motor M1, a control command for rotating the platen roller 6 and the transfer roller 17. In accordance with the input of a control command, the first motor M1 outputs a driving force with which the platen roller 6 and the transfer roller 17 transport the recording sheet P in the transport direction S2.

In S03, it is determined whether the recording sheet P has been detected at the printing position A. For example, the control portion 30 detects that the front-end portion of the recording sheet P has reached the printing position A based on the detection result of the front-end detection sensor 31. When the recording sheet P is not detected at the printing position A (in the case of “NO” in the S03), the printer 1 waits until detection of the recording sheet P.

When the recording sheet P has been detected at the printing position A (in the case of “YES” in the S03), the printing starts in S04. The control portion 30 appropriately outputs a control command to the thermal head 5 of the printing portion 3 based on the printing information obtained in the S01. The thermal head 5 generates heat in accordance with the control command output from the control portion 30, thereby performing the printing on an appropriate position of the recording sheet P.

In S05, the type of printing in the printing control is determined. For example, the control portion 30 determines the type of printing based on the printing information obtained in the S01. When the type of printing is the plain sheet printing, the flow proceeds to S06. Meanwhile, when the type of printing is the label sheet printing, the flow proceeds to S12.

Referring also to FIG. 8 to FIG. 10, the flow of the plain sheet printing subsequent to the S06 will be described.

In the S06, the upward-and-downward moving block 13 is moved to the first position. For example, the control portion 30 outputs, to the second motor M2 configured to drive the upward-and-downward moving block 13, a control command (e.g., a plain sheet printing signal) for moving the upward-and-downward moving block 13 to the first position.

In S07, whether the printing has been completed is determined. When the printing has been completed (in the case of “YES” in the S07), the operation of the thermal head 5 is stopped, and the flow proceeds to S08. When the printing has not been completed (in the case of “NO” in the S07), the printing continues until completion of the printing.

In the S08, the platen roller 6 and the transfer roller 17 are stopped at the timing when the position at which the printing on the recording sheet P has been completed (printing-completed portion) comes to the cutting position B.

Also, in the S08, the upward-and-downward moving block 13 is moved to the third position, and the recording sheet P is cut. After completion of the printing, at the timing when the printing-completed portion of the recording sheet P comes to the cutting position B, the control portion 30 outputs, to the second motor M2 configured to drive the upward-and-downward moving block 13, a control command (e.g., a cutting signal) for moving the upward-and-downward moving block 13 to the third position. Note that, at the time of moving from the first position to the third position, the transfer part 9 does not rotate, and the transfer roller 17 moves in a direction indicated by arrow W. Thus, a sufficient pressing force for transfer of the adhesive is not added to the transfer part 9 side. In addition, a region of the adhesive tape sheet T that contacts the transfer roller 17 is free of the adhesive after transfer thereof, and the adhesive is not transferred from the adhesive tape sheet T to the recording sheet P.

In S09, the upward-and-downward moving block 13 is moved to the first position.

In S10, the control portion 30 outputs an operation signal to the clutch CL, and the clutch CL releases the connection between the gear line G1 and the platen roller 6, thereby stopping transmission of the motive force to the platen roller 6 and rotating the transfer roller 17. By the rotation of the transfer roller 17, the recording sheet P2 is discharged, as a printed plain sheet, downstream of the transport direction S2 along the transport guide 14.

In S11, it is determined whether the rear end of the recording sheet P2 has passed through the adhesive transfer position C. When the rear end of the recording sheet has not passed through the adhesive transfer position C (in the case of “NO” in S11), driving of the transfer roller 17 continues until the rear end of the recording sheet passes through the adhesive transfer position C. Meanwhile, when the rear end of the recording sheet has passed through the adhesive transfer position C (in the case of “YES” in S11), the plain sheet printing is determined to be completed, and the transfer roller 17 is stopped and the present control flow is ended.

FIG. 8 is a view illustrating a first phase of the plain sheet printing mode, and a state in which the upward-and-downward moving block 13 is at the first position. FIG. 8 corresponds to a period of from the S06 to before completion of the printing in the S07 in FIG. 7. As illustrated in FIG. 8, at the first position, both of the adhesive transfer unit 7 and the movable blade 43 are at positions spaced from the recording sheet P on the transport path in the negative Z direction. At the first position during the plain sheet printing, a sufficient gap is between the transfer part 9 and the transfer roller 17, and the adhesive tape sheet T is not moved. While the platen roller 6 is pressing the recording sheet P toward the thermal head 5 by the biasing force f1, the platen roller 6 rotates in a direction indicated by arrow M1, thereby transporting the recording sheet P in the transport direction S2. Also, while the transfer roller 17 is being pressed toward the transport guide 14 by the biasing force f2, the transfer roller 17 rotates in a direction indicated by arrow M2, thereby transporting the recording sheet P in the transport direction S2.

FIG. 9 is a view illustrating a second phase of the plain sheet printing mode, and a state in which the upward-and-downward moving block 13 is moved to the third position. FIG. 9 corresponds to a period of from after completion of the printing in the S07 to the S08 in FIG. 7. At the second phase of the plain sheet printing mode, the printing has been completed, and the platen roller 6 and the transfer roller 17 are stopped. As indicated by arrow M3 in FIG. 9, the movable blade rack 45 is moved upward. Along with this, as indicated by arrow M4, the adhesive transfer unit 7 is moved upward, and as indicated by arrow M5, the movable blade 43 is moved upward. The movable blade rack 45, the adhesive transfer unit 7, and the movable blade 43 are moved upward by the same amount. Furthermore, the transfer roller 17 is pushed up along with the upward movement of the adhesive transfer unit 7, and as indicated by the arrow W, the rotation shaft of the transfer roller 17 moves downward in the transport direction (see FIG. 15C). At the third position, the movable blade 43 moves across the transport path toward the positive Z direction and reaches a position exceeding the transport path, and can cut the recording sheet P on the transport path.

At the third position in the plain sheet printing mode, the transfer roller 17 moves in the direction indicated by the arrow W. Thus, a sufficient pressing force for transfer of the adhesive is not added to the transfer part 9 side, and the transfer part 9 does not rotate. Therefore, the adhesive is not transferred from the adhesive tape sheet T to the recording sheet P.

FIG. 10 is a view illustrating a third phase of the plain sheet printing mode, and a state in which the upward-and-downward moving block 13 is moved to the first position. FIG. 10 corresponds to a period of from the S09 to the S10 in FIG. 7. As indicated by arrow M6 in FIG. 10, the movable blade rack 45 is moved downward. Along with this, the adhesive transfer unit 7 also moves downward as indicated by arrow M7, and also the movable blade 43 moves downward as indicated by arrow M9. The movable blade rack 45, the adhesive transfer unit 7, and the movable blade 43 are moved downward by the same amount. Furthermore, as indicated by arrow M8 in FIG. 10, along with the downward movement of the adhesive transfer unit 7, the rotation shaft of the transfer roller 17 returns to the initial position as illustrated in FIG. 8. As a result, at the first position as illustrated in FIG. 10, both of the adhesive transfer unit 7 and the movable blade 43 return to the positions spaced from the recording sheet P on the transport path in the negative Z direction. The transfer roller 17 is still driven in this state, and thereby the cut recording sheet P2 is discharged out of the printer 1.

Referring back to FIG. 7 and referring also to FIG. 11 to FIG. 14, the flow of the label sheet printing subsequent to the S12 will be described.

In the S12, the upward-and-downward moving block 13 is moved to the second position. Thereby, the adhesive tape sheet T of the transfer part 9 contacts the rear surface of the recording sheet P. In this state, in response to the recording sheet P being transported by the transfer roller 17, the transfer part 9 contacting the recording sheet P rotates to pull out the adhesive tape sheet T from the accommodation roller 11. At the contact portion between the transfer part 9 and the recording sheet P, the adhesive tape sheet T wound around the transfer part 9 is also moved toward the transport direction. Thereby, the adhesive G of the adhesive tape sheet T contacting the recording sheet at the contact portion between the transfer part 9 and the recording sheet P continues to be transferred to the rear surface of the recording sheet P, thereby forming a label sheet having an adhesive surface on the rear surface thereof. The tape sheet T′ after the adhesive G has been transferred passes through the transfer part 9 and is wound and recovered by the recovery roller 12.

In S13, whether the printing has been completed is determined. When the printing has been completed (in the case of “YES” in the S13), the operation of the thermal head 5 is stopped, and the flow proceeds to S14. When the printing has not been completed (in the case of “NO” in the S13), the printing continues until completion of the printing.

In S14, the platen roller 6 and the transfer roller 17 are stopped at the timing when the printing-completed portion of the recording sheet P comes to the cutting position B. Also, the upward-and-downward moving block 13 is moved to the third position, and the recording sheet P is cut.

In S15, the upward-and-downward moving block 13 is moved to the second position, and to such a position as to be able to transfer the adhesive G to the rear surface of the recording sheet P2.

In the S10 after the S15, by the rotation of the transfer roller 17, the recording sheet P2 is discharged downstream of the transport direction S2 along the transport guide 14, as a label sheet formed by applying the adhesive G to the rear surface of the recording sheet P2, followed by printing.

In the S11, it is determined whether the rear end of the cut recording sheet has passed the adhesive transfer position C; i.e., the contact position with the transfer roller 17. When the rear end of the recording sheet has not passed through the adhesive transfer position C (in the case of “NO” in the S11), the transfer roller 17 continues to drive until the rear end of the recording sheet passes through the adhesive transfer position C. Meanwhile, when the rear end of the recording sheet has passed through the adhesive transfer position C (in the case of “YES” in the S11), the label sheet printing is determined to be completed, and the transfer roller 17 is stopped and the present control flow is ended.

FIG. 11 is a view illustrating a first phase of the label sheet printing mode, and a state in which the upward-and-downward moving block 13 is moved to the second position. FIG. 12 is a view illustrating a positional relationship between the transfer roller 17 and the adhesive transfer unit 7 at the second position. The outline of FIG. 12 is similar to that of FIG. 4. FIG. 11 corresponds to a period of from the S12 to before completion of the printing in the S13 in FIG. 7. As indicated by arrow M10 in FIG. 11, the movable blade rack 45 is moved upward. Along with this, as indicated by arrow M11 in FIG. 11 and FIG. 12, the adhesive transfer unit 7 is moved upward to a position at which the transfer part 9 contacts the transfer roller 17. Although the movable blade 43 also moves upward, the movable blade 43 only moves to a position spaced from the recording sheet P. The movable blade rack 45, the adhesive transfer unit 7, and the movable blade 43 are moved upward by the same amount.

As illustrated in FIG. 11 and FIG. 12, at the second position, the adhesive transfer unit 7 is at such a position as to be able to add the adhesive to the recording sheet P, and as illustrated in FIG. 11, the movable blade 43 is at such a position as to be unable to cut the recording sheet P on the transport path. Also, in FIG. 11, the platen roller 6 presses the recording sheet P toward the thermal head 5 by the biasing force f1, and rotates in the direction by the arrow M1, thereby transporting the recording sheet P in the transport direction S2. Also, the transfer roller 17 is pressed toward the transport guide 14 by the biasing force f2, rotates in the direction indicated by the arrow M2, and can add the adhesive to the recording sheet P.

FIG. 13 is a view illustrating a second phase of the label sheet printing mode, and a state in which the upward-and-downward moving block 13 is moved to the third position. FIG. 13 corresponds to a period of from after completion of the printing in the S13 to the S14 in FIG. 7. In the second phase of the label sheet printing mode, the printing has been completed, and the platen roller 6 and the transfer roller 17 are stopped. As indicated by arrow M12 in FIG. 13, the movable blade rack 45 is moved to a higher position than at the second position. Along with this, as indicated by arrow M13, the adhesive transfer unit 7 also moves to a higher position than at the second position, and as indicated by arrow M14, the movable blade 43 also moves to a higher position than at the second position. The movable blade rack 45, the adhesive transfer unit 7, and the movable blade 43 are moved upward by the same amount. Furthermore, the transfer roller 17 is pushed up along with the upward movement of the adhesive transfer unit 7, and as indicated by the arrow W, the rotation shaft of the transfer roller 17 moves downward in the transport direction (see FIG. 15C). At the third position, the movable blade 43 moves across the transport path toward the positive Z direction and reaches a position exceeding the transport path, and can cut the recording sheet P on the transport path.

At the third position in the label sheet printing mode, the transfer roller 17 moves in the direction indicated by the arrow W. Thus, a sufficient pressing force for transfer of the adhesive is not added to the transfer part 9 side, and the transfer part 9 does not rotate. Therefore, the adhesive is not transferred from the adhesive tape sheet T to the recording sheet P. Since the adhesive G is transferred to the recording sheet P in the first phase of the label sheet printing mode, as illustrated in FIG. 13, the adhesive G is applied to the rear surface of the recording sheet P downstream, in the transport direction, of a position at which the recording sheet P contacts the transfer roller 17.

FIG. 14 is a view illustrating a third phase of the label sheet printing mode, and a state in which the upward-and-downward moving block 13 is moved to the second position. FIG. 14 corresponds to a period of from the S15 to the S10 in FIG. 7. As indicated by arrow M15 in FIG. 14, the movable blade rack 45 is moved downward. Along with this, the adhesive transfer unit 7 also moves downward as indicated by arrow M16, and also the movable blade 43 moves downward. The movable blade rack 45, the adhesive transfer unit 7, and the movable blade 43 are moved downward by the same amount. Furthermore, as indicated by arrow M17, along with the downward movement of the adhesive transfer unit 7, the rotation shaft of the transfer roller 17 returns to the initial position as illustrated in FIG. 11. As a result, at the second position as illustrated in FIG. 14, the adhesive transfer unit 7 is at such a position as to be able to contact the recording sheet P and add the adhesive to the recording sheet P, and the movable blade 43 returns to such a position as to be unable to cut the recording sheet P on the transport path. The transfer roller 17 is still driven in this state, and thereby the adhesive G is applied to the entirety including the rear-end portion of the cut recording sheet P2. As subsequent to the cutting of the recording sheet P, the rotation of the platen roller 6 is stopped. Meanwhile, the transfer roller 17 presses the cut recording sheet P2 toward the transport guide 14 by the biasing force f2, and by rotating the transfer roller 17 in the direction indicated by the arrow M2, it is possible to discharge the recording sheet P2 out of the printer 1.

Referring to FIG. 15A to FIG. 15C, one example of the structure with which the transfer roller 17 moves in the direction indicated by the arrow W in FIG. 9 and FIG. 13 will be described.

FIG. 15A to FIG. 15C are explanatory views of the movement of the transfer roller 17 at the time of moving from the second position to the third position. FIG. 15A illustrates a state at the second position, FIG. 15B illustrates a state of moving from the second position to the third position, and FIG. 15C illustrates a state at the third position. FIG. 15A to FIG. 15C each schematically illustrate a positional relationship of the transfer roller 17, the rotation shaft 17A, the transfer part 9, the gear GL, and the gear G17. The gear GL is, as illustrated in FIG. 2, a gear at the most downstream side of the transport direction of the gear line G1 that transmits the driving force from the first motor M1. The gear G17 is, as illustrated in FIG. 2, a gear that is coaxially disposed with the rotation shaft 17A and rotates together with the transfer roller 17.

In the present embodiment, the leading-end portion of the rotation shaft 17A is inserted into a guide groove 18. The guide groove 18 is provided in a fixed component of the printer 1, such as the inner wall of the housing 2. The guide groove 18 is formed in an approximately L shape as viewed from the Y direction. The guide groove 18 includes: a radial direction portion 18A formed along a radial direction of the gear GL; and a circumferential direction portion 18B formed along a circumferential direction of the gear GL. The end portion in the positive Z direction of the radial direction portion 18A is connected to the end portion in the negative X direction of the circumferential direction portion 18B, thereby forming the L shape groove.

Also, in FIG. 15A to FIG. 15C, the addendum circle of the gear GL or G17 is denoted by a solid line, the dedendum circle thereof is denoted by a dotted line, and an approximately middle circle between the addendum circle and the dedendum circle (reference circle) is denoted by a chain line.

In the present embodiment, the rotation shaft 17A always receives a biasing force f3 applied toward the shaft center thereof, as indicated by arrow f3 in FIG. 15A to FIG. 15C. The biasing force f3 can be generated by, for example, connecting an elastic member (e.g., a spring) to the rotation shaft 17A. When the biasing force f3 is generated by an elastic member, one end of the elastic member is fixed to the rotation shaft 17A and the other end is fixed to the housing 2. The elastic member is disposed on the positive Z-direction side of the gear G17 so that the direction of the biasing force f3 becomes, as illustrated in FIG. 15C, on a line coaxial with straight line R that passes through the shaft centers of the gear GL, the gear G17, and the rotation shaft 17A at the third position.

As illustrated in FIG. 15A, at the second position, the transfer part 9 is disposed at such a position as to contact the transfer roller 17 (see FIG. 11 and FIG. 12). At this time, the rotation shaft 17A is disposed at the lower end of the radial direction portion 18A of the guide groove 18. Since the radial direction portion 18A extends along the Z direction, a negative Z direction component of the biasing force f3 acts on the rotation shaft 17A, thereby retaining the rotation shaft 17A at the lower end of the radial direction portion 18A. The negative Z direction component of the biasing force f3 that acts thereon at this time corresponds to the biasing force f2 as illustrated in, for example, FIG. 1.

When the rotation shaft 17A is at the lower end of the radial direction portion 18A of the guide groove 18, the gear G17 is deeply engaged with the gear GL at the dedendum position. Thereby, when the gear GL rotates as indicated by arrow M18, a rotational driving force is transmitted to the gear G17, and the gear G17 and the transfer roller 17 rotate in the direction indicated by the arrow M2.

As illustrated in FIG. 15B, during moving from the second position to the third position, the transfer part 9 moves upward together with the movable blade rack 45, as indicated by arrow M13. The transfer roller 17 is pushed upward by the transfer part 9, and moves against the biasing force f3 toward the positive Z direction along the radial direction portion 18A of the guide groove 18. As a result, the rotation shaft 17A reaches the upper end of the radial direction portion 18A, as indicated by arrow M19. Also, the radial direction portion 18A is formed to have such a shape that even when the rotation shaft 17A is at the upper end of the radial direction portion 18A, the engagement between the gear G17 and the gear GL is maintained with the addendum circle of the gear G17 being at the reference circle of the gear GL, as illustrated in FIG. 15B. Therefore, even in the state of FIG. 15B, the rotation of the gear GL can transmit the rotational driving force to the gear G17.

When the rotation shaft 17A has reached the upper end of the radial direction portion 18A, the rotation shaft 17A can move along the circumferential direction portion 18B of the guide groove 18. Here, the rotational driving force M18 of the gear GL is set to be greater than the biasing force f3. Also, since the circumferential direction portion 18B of the guide groove 18 is formed along the circumferential direction of the gear GL, even when the rotation shaft 17A moves along the circumferential direction portion 18B, the addendum circle of the gear G17 is maintained to be positioned at the reference circle of the gear GL. Thereby, the rotation shaft 17A receives an external force toward the positive X direction from the rotational driving force M18 of the gear GL, moves along the circumferential direction portion 18B as indicated by arrow M20, and reaches the end portion in the positive X direction of the circumferential direction portion 18B. As a result, as illustrated in FIG. 15C, the transfer roller 17 pivotally rotates toward the W direction about the gear GL, and moves to the third position.

Note that, in FIG. 15A to FIG. 15C, the movement of the transfer roller 17 toward the W direction during moving from the second position to the third position (FIG. 13) is described. The movement of the transfer roller 17 toward the W direction during moving from the first position to the third position (FIG. 9) is performed in the same manner. Also, the returning movement of the transfer roller 17 as indicated by the arrow M8 in FIG. 10 and the arrow M17 in FIG. 14 can be realized by moving the transfer part 9 in the order of FIG. 15C to FIG. 15B to FIG. 15A using the structure as illustrated in FIG. 15A to FIG. 15C.

As such, the printer 1 according to the present embodiment includes: the printing portion 3, which includes the thermal head 5 which performs the printing on the recording sheet P in the transport path that transports the recording sheet P which is the elongated recording medium, and the platen roller 6 which is disposed to face the thermal head 5 and transports downstream the recording sheet P on which printing is performed by the thermal head 5; the cutter 4, which is disposed downstream of the printing portion 3 in the transport direction S2, includes the fixed blade 41 and the movable blade 43, and cuts the recording sheet P along the width direction thereof by movement of the movable blade 43; the adhesive transfer unit 7, which is disposed downstream of the cutter 4 in the transport direction S2 and adds the adhesive G to the rear surface of the recording sheet P; and the transfer roller 17, which is disposed to face the adhesive transfer unit 7 and transports the recording sheet P downstream while pressing the recording sheet P toward the adhesive transfer unit 7. The adhesive transfer unit 7 can be moved together with the movable blade 43 along the moving direction of the movable blade 43. In other words, the adhesive transfer unit 7 is integrally assembled together with the movable blade 43, and provided so as to move together with the movable blade 43 along the moving direction of the movable blade 43.

Since the printer 1 of the present embodiment can move the adhesive transfer unit 7 and the movable blade 43 using the second motor M2 as the sole driving source, another driving source is not provided for moving the adhesive transfer unit 7. This can achieve space saving. As a result, the printer 1 is suppressed from increasing in size, and can form the printed product P2 by adding the adhesive G to the recording sheet P and cutting the recording sheet P. Also, since the transfer roller 17 is disposed at such a position as to face the adhesive transfer unit 7; i.e., downstream of the cutter 4 in the transport direction S2, the transfer roller 17 can automatically discharge, out of the printer 1, the recording sheet P2 that has been cut with the cutter 4. This can increase printing efficiency. Furthermore, since the transfer roller 17 presses the recording sheet P toward the adhesive transfer unit 7, it is possible to reliably transfer the adhesive G from the adhesive transfer unit 7 to the recording sheet P.

Also, according to the printer 1 of the present embodiment, the adhesive transfer unit 7 is preferably connected to the movable blade rack 45 by which the movable blade 43 is retained. With this configuration, it is possible to reliably move the adhesive transfer unit 7 together with the movable blade 43 along the moving direction of the movable blade 43. Also, for example, in a case where connecting positions to the adhesive transfer units are provided in larger number than the number of the adhesive transfer units along the width direction of the movable blade rack 45, when a user of the printer 1 selects appropriate connecting positions to the adhesive transfer units from those connecting positions in accordance with the intended application of the printed product P2, it is possible to readily adjust which position to apply the adhesive in the rear surface of the printed product P2. Also, since the application position of the adhesive can be adjusted, it is also possible to adjust an adhesive force and an attachable position of the printed product P2, and perform printing of label sheets in accordance with various applications.

Also, according to the printer 1 of the present embodiment, the adhesive transfer unit 7 is preferably detachably connected to the movable blade rack 45. With this configuration, since the adhesive transfer unit 7 can be removed from the movable blade rack 45, replacement or maintenance of the adhesive transfer unit 7 can become easier, and the lifetime of the device can be improved.

Also, according to the printer 1 of the present embodiment, the upward-and-downward moving block 13 (especially, the adhesive transfer unit 7 and the movable blade 43) is moved between the first position, the second position, and the third position in the moving direction S3. At the first position, both of the adhesive transfer unit 7 and the movable blade 43 are at such positions as to be spaced from the recording sheet P on the transport path. At the second position, the adhesive transfer unit 7 is at such a position as to be able to contact the recording sheet P and add the adhesive G to the recording sheet P, and the movable blade 43 is at a position as to be unable to cut the recording sheet P on the transport path. At the third position, both of the adhesive transfer unit 7 and the movable blade 43 are at positions as to be exceeding the transport path, and the movable blade 43 is at such a position as to be able to cut the recording sheet P on the transport path. Furthermore, at the third position, the transfer roller 17 is pressed by the adhesive transfer unit 7 and moves, and the adhesive transfer unit 7 can move to a position exceeding the transport path. With this configuration, it is possible to perform an operation by the adhesive transfer unit 7 to add the adhesive G to the recording sheet P and an operation by the movable blade 43 to cut the recording sheet P on the transport path, while moving the adhesive transfer unit 7 and the movable blade 43 together. Furthermore, since the transfer roller 17 disposed to face the adhesive transfer unit 7 is moved, the adhesive transfer unit 7 readily moves to a position exceeding the transport path. This can reduce load to the cutting operation by the movable blade 43 moving together with the adhesive transfer unit 7, and the movable blade 43 can readily cut the recording sheet P.

Also, according to the printer 1 of the present embodiment, at the third position, the transfer roller 17 is pressed by the adhesive transfer unit 7 and moves downward in the transport direction S2 of the recording sheet P. Thus, the transfer roller 17 can deviate from the moving direction of the transfer part 9 such that the transfer roller 17 is away from the moving direction of the adhesive transfer unit 7 (positive Z direction). Thereby, the transfer roller 17 does not inhibit the adhesive transfer unit 7 from moving toward the positive Z direction, and the adhesive transfer unit 7 can move exceeding the transport path by an increased amount. This can also increase the amount of movement of the movable blade 43 moving together with the adhesive transfer unit 7, and the movable blade 43 can more reliably cut the recording sheet P.

Also, according to the printer 1 of the present embodiment, when the printer 1 prints the recording sheet P as a label sheet having an adhesive surface on the rear surface thereof, first, the adhesive transfer unit 7 and the movable blade 43 move to the second position, and the printing portion 3 performs the printing on the recording sheet P and the adhesive transfer unit 7 adds the adhesive G to the recording sheet P. Second, the adhesive transfer unit 7 and the movable blade 43 move to the third position, and the movable blade 43 cuts the recording sheet P. Meanwhile, when the printer 1 prints the recording sheet P as a plain sheet having no adhesive surface on the rear surface thereof, first, the adhesive transfer unit 7 and the movable blade 43 move to the first position, and the printing portion 3 performs the printing on the recording sheet P and the adhesive transfer unit 7 does not add the adhesive G to the recording sheet P. Second, the adhesive transfer unit 7 and the movable blade 43 move to the third position, and the movable blade 43 cuts the recording sheet P. With this configuration, by appropriately moving, between the three phases of the first to third positions, the position of the upward-and-downward moving block 13 (especially, the adhesive transfer unit 7 and the movable blade 43) in the moving direction S3, the label sheet printing and the plain sheet printing can be selectively performed by the sole printer 1, and the printer 1 can be versatile.

In the above-described embodiments, the transfer part 9 as illustrated has a roller structure. However, the transfer part 9 may have a given structure other than the roller structure as long as the transfer part 9 can press the adhesive tape sheet T against the recording sheet P and transfer the adhesive G thereto. For example, like a well-known correction tape sheet, the transfer part 9 may have a structure in which a head for pushing the tape sheet to an intended object is in the form of a plate. In this structure, the adhesive tape sheet T is attached to a plate-form head from one main surface thereof across the tip-end portion thereof to the other main surface. The tip-end portion or one of the main surfaces is pushed on the recording sheet P by the transfer roller 17, and the adhesive G at the contact portion with the recording sheet P is transferred to the recording sheet P. Also, the head may have a given shape as long as the head can push the adhesive tape sheet T on the recording sheet P. For example, the head may be a shape in the form of a solid other than the plate form; e.g., the shape of a tip in a pushing direction (thickness direction) is formed to be pointed, or an acute angle.

Also, in the above-described embodiments, the adhesive G applied to the adhesive tape sheet T is transferred to the recording sheet P by the adhesive transfer unit 7. However, a given configuration is employable as long as, at least, the adhesive G can be added to the rear surface of the recording sheet P. The employable configuration may be a configuration that adds the adhesive G to the recording sheet P by a given method other than transfer, such as a configuration in which the adhesive G is discharged and applied to the recording sheet P.

Also, in the above-described embodiments, the recording sheet P is described as a recording medium on which the printing is performed by the printing portion 3 and to which the adhesive G is added by the adhesive transfer unit 7. However, a given recording medium is employable as long as the recording medium is in the form of a thin plate similar to a sheet, and can undergo printing on one surface thereof and receive an adhesive on the other surface. The employable recording medium may be, for example, a thin plate made of resin.

Also, in the above-described embodiments, the printer 1 can perform two types of printing; i.e., “label sheet printing” and “plain sheet printing”. However, the printer 1 may be a printer dedicated to the label sheet printing. In this case, the positions to which the upward-and-downward moving block 13 can move are not the above three phases of the first to third positions, but may be only two phases of the second position and the third position. In other words, the printer 1 may be configured so as not to have a state at the first position; i.e., both of the adhesive transfer unit 7 and the movable blade 43 are not moved to positions spaced in the negative Z direction from the recording sheet P on the transport path. Thereby, the moving structure of the upward-and-downward moving block 13 can be simplified, and the device can be further reduced in size.

Also, in the above-described embodiments, the Z direction that is the moving direction of the upward-and-downward moving block 13 is the vertical direction. The moving direction of the upward-and-downward moving block 13 may be a direction other than the vertical direction, such as the horizontal direction. In this case, the transport direction S2 of the recording sheet P may be a direction other than the horizontal direction, such as the vertical direction.

In the above-described embodiments, the front-end detection sensor 31 and the rear-end detection sensor 32 are used to respectively detect passage of the recording sheet P through the printing position A and passage of the recording sheet P through the adhesive transfer position C. Based on the detection results, the control portion 30 controls the timing for moving the height position of the upward-and-downward moving block 13. However, as long as the control portion 30 can identify the position of the recording sheet P on the transport path, the printer 1 of the present embodiment may be configured such that components other than the front-end detection sensor 31 and the rear-end detection sensor 32 are used to detect the position of the recording sheet P.

In the above-described embodiments, the adhesive transfer unit 7 is detachably connected to the movable blade rack 45. However, the adhesive transfer unit 7 may be fixed to the movable blade rack 45. Also, in the above-described embodiments, the adhesive transfer unit 7 and the movable blade 43 are connected to the movable blade rack 45. However, as long as, at least, the adhesive transfer unit 7 and the movable blade 43 can move together, a connection structure other than the configuration in which the adhesive transfer unit 7 and the movable blade 43 are connected to the movable blade rack 45, such as a configuration in which the adhesive transfer unit 7 and the movable blade 43 are directly connected to each other, may be used.

In the above-described embodiments, when the upward-and-downward moving block 13 is moved to the third position, the transfer roller 17 is pushed to deviate from the moving direction (positive Z direction) of the transfer part 9 while the rotation shaft 17A is moved downstream in the transport direction S2 of the recording sheet P as indicated by the arrow W in FIG. 9, FIG. 13, and FIG. 15C. The moving direction of the transfer roller 17 is not limited thereto as long as, at least, the transfer roller 17 is away from the moving direction of the transfer part 9 and does not inhibit the movement of the adhesive transfer unit 7 toward the positive Z direction. For example, the rotation shaft 17A may move in a direction opposite to the direction indicated by the arrow W; i.e., upstream in the transport direction S2 so that the transfer roller 17 can deviate from the moving direction of the transfer part 9.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A printer, comprising:
a printing portion configured to perform printing on a recording medium;
a cutting portion including a fixed blade and a movable blade and configured to cut the recording medium along a width direction thereof by movement of the movable blade;
an adhesive adding portion configured to add an adhesive to one surface of the recording medium; and
a transfer roller disposed to face the adhesive adding portion and configured to press the recording medium toward the adhesive adding portion and transport the recording medium,
wherein the adhesive adding portion is integrally assembled together with the movable blade, and provided to move together with the movable blade along a moving direction of the movable blade.

2. The printer according to claim 1, further comprising:
a housing including
a body, and
a cover provided to the body so as to be openable and closable,
wherein the printing portion includes a recording head configured to perform the printing on the recording medium, and a platen roller disposed to face the recording head and configured to transport downstream the recording medium on which the printing is performed by the recording head,
the recording head, the fixed blade, and the transfer roller are disposed in the cover, and
the platen roller, the movable blade, and the adhesive adding portion are disposed in the body.

3. The printer according to claim 1,
wherein the adhesive adding portion and the movable blade can move, in the moving direction, between:
a first position at which both of the adhesive adding portion and the movable blade are at positions spaced from the recording medium on a transport path;
a second position at which the adhesive adding portion is at such a position as to be able to contact the recording medium and add the adhesive to the recording medium, and the movable blade is at such a position as to be unable to cut the recording medium on the transport path; and
a third position at which both of the adhesive adding portion and the movable blade are at positions exceeding the transport path, and the movable blade is at such a position as to be able to cut the recording medium on the transport path, and
the transfer roller at the third position is configured to be pressed by the adhesive adding portion and move so that the adhesive adding portion can move to a position exceeding the transport path.

4. The printer according to claim 3,
wherein the transfer roller is pressed by the adhesive adding portion and moves in a transport direction of the recording medium.

5. The printer according to claim 3,
wherein in a case where the recording medium is printed as a label sheet having an adhesive surface on a rear surface thereof,
first, the adhesive adding portion and the movable blade move to the second position, and the printing portion performs the printing on the recording medium and the adhesive adding portion adds the adhesive to the recording medium, and
second, the adhesive adding portion and the movable blade move to the third position, and the movable blade cuts the recording medium; or
in a case where the recording medium is printed as a plain sheet having no adhesive surface on a rear surface thereof,
first, the adhesive adding portion and the movable blade move to the first position, and the printing portion performs the printing on the recording medium and the adhesive adding portion does not add the adhesive to the recording medium, and
second, the adhesive adding portion and the movable blade move to the third position, and the movable blade cuts the recording medium.
